(19) United States
(12) Patent Application Publication
(10) Pub. No.: US 2016/0312612 A1
(43) Pub. Date: Oct. 27, 2016

(54) Locating Device of Rotary Piston Mechanism

(71) Applicant: HANLOG OY, Valkeakoski (FI)

(72) Inventor: Risto AUVINEN, Toivala (FI)

(21) Appl. No.: 15/179,210

(22) Filed: Jun. 10, 2016

Related U.S. Application Data
(63) Continuation of application No. PCT/FI2014/050833, filed on Nov. 5, 2014.

(30) Foreign Application Priority Data
Dec. 12, 2013 (FI) 20136249

(51) Int. Cl. F01C 1/22; G01M 15/06

(52) U.S. Cl. CPC F01C 1/22; G01M 15/06

(57) ABSTRACT

The invention relates to a locating device of a rotary piston mechanism, by means of which, rotational motions of a moving piston and a power transmission part on a centre axis of the piston or on its extension are supported by a locating joint in a rotation support point of the piston or in its immediate vicinity, closable and openable according to piston positions and controlled centrically to a cardan shaft by a crank arm formed between the cardan shaft and the centre axis of the piston such that a statically stable support structure is provided for the motions of the piston, for the rotational motions around the rotation support point of the power transmission part on the centre axis of the piston or on its extension and for the rotation around the centre axis of the piston, and an eccentric shaft is disconnected.

This application is a continuation of International Patent Application No. PCT/FI2014/050833 filed on Nov. 5, 2014.

### BACKGROUND OF THE INVENTION

The invention relates to a locating device of a rotary piston mechanism, which includes a support structure for supporting the motions of a torque arm between a rotation support point of the piston and an extremity of a torque structure of the piston, for supporting the motions of a torque arm between a centre axis of the piston and an extremity of a torque structure of the piston and for supporting the motions of a power transmission part on the centre axis of the piston or on its extension, being immobile in relation to the piston.

A device supporting and centering the motions of a rotary piston is previously known from the rotary piston engine described in specification U.S. Pat. No. 3,097,632. In this engine, the centering and supporting of piston motions and the conveyance of motion energy between the piston and a crankshaft fastened in the middle of a piston motion space is arranged by an eccentric in a central cavity of the piston, which eccentric is connected to the crankshaft in an immobile way and which, together with the crankshaft, moves in a rotation speed multiple in relation to the rotation motions of the piston, and torque which loads the crankshaft is conveyed between the eccentric and the moving piston causing high surface pressure, stress which loads the piston motions and power transmission, and energy losses, and the lengths of a torque arm rotationally affecting the polar axis of the piston and a crank arm rotationally affecting the eccentric shaft operating as the crankshaft vary frequently when the positions of the piston and the eccentric change causing frequent variation in torque power and losses in the mechanical energy output of the engine, and the rotational motion of the piston around its centre axis will not convey in power transmission.

A support arrangement controlling the motions of a piston of a rotary piston mechanism is previously known from the planetary-motion rotary piston engine described in international specification WO2010026288, in which stroke cycles of the piston rotate around two polar axes and the conveyance of motion energy between the piston and the shaft is arranged by a crank device on the centre axis of the piston, being immobile in relation to the piston. In this engine, the support of piston motions is arranged by a pivoted beam, by which a crank device is connected to a flywheel, and by piston angles touching the walls of the piston motion space in varying positions and varying surface pressure prevailing, whereby the centering of the piston and the crank device on the centre axis of the piston remains lacking and the support is non-static, and varying friction in the different positions of the piston and variation in the distance between the rotation support point and the centre axis of the piston causes irregularity in the mechanical energy output of the engine and motion energy losses, and these rotational motions of the piston of the engine around the polar axes will not convey in power transmission between the piston and the main shaft.

A support arrangement controlling the motions of a rotary piston, which includes a support structure for supporting the motions of a torque arm between a rotation support point of the piston of the rotary piston mechanism and an extremity of a torque structure of the piston, for supporting the motions of a torque arm between a centre axis of the piston and an extremity of a torque structure of the piston and for supporting the motions of a power transmission part on the centre axis of the piston or on its extension, being immobile in relation to the piston, is already known of the rotary piston engine described in international specification WO2013014335A1. In this engine, the structure which supports the piston motions are piston angles which touch the walls of a piston motion space in varying positions and varying surface pressure prevailing, whereby the centering of the piston and a crank device on the centre axis of the piston remains lacking and the support is non-static, and varying friction in the different positions of the piston and variation in the distance between the rotation support point and the centre axis of the piston causes irregularity in the mechanical energy output of the engine and motion energy losses.

An object of the inventions is to eliminate the above disadvantages and to introduce a locating device of a rotary piston mechanism which supports and stabilises the run and power transmission of the rotary piston mechanism. A further object of the invention is to provide a locating device of a rotary piston mechanism by means of which the motions of a power transmission part immovably fastened on the centre axis of the piston are controlled centrally.

### DESCRIPTION OF THE INVENTION

According to the invention in the locating device of the rotary piston mechanism, the rotational motion of a moving piston and a power transmission part on the centre axis of the piston or on its extension is supported by a locating joint formed at the point of a support point of the rotational motion of the piston or in its immediate vicinity, being closable and openable according to piston positions, a cardan shaft of which is at the touching point of a static joint part formed on a frame circumference or an eccentric circumference or on both circumferences together and a joint part on a circumference surrounding the centre axis of the piston at the end of a torque arm, and controlled by a crank arm between a joint part at the end of the torque arm of the piston and the crank arm of the centre axis of the piston to the cardan shaft centrically such that a path of the centre axis of the piston and the power transmission part on it is of the shape of a circular arch and symmetrical in relation to the centre point of the motion space of the piston, and a centrical and statically stable support structure is formed for the motions of the piston, the motions rotating around the rotation support point of the power transmission part on the centre axis of the piston or on its extension and the rotation around the centre axis of the piston, an eccentric in connection with which, having joint parts of the locating joint on its circumference, is disconnected from the power transmission such that torque loading the mechanism will not convey between the eccentric and the piston. Then, the locating joint and the crank arm of the locating device of the rotary piston stabilise the motions of the power transmission parts in relation to each other, boost and intensify the conveyance of forces rotationally affecting the polar axis of the piston and the centre axis of the piston between the piston and the crankshaft and relieve surface pressure between the piston angles and the walls of the motion space and between the piston and the eccentric movably fastened in relation to the piston. The motions of the power transmission part immovably fastened on the centre axis of the piston are controlled centrally such that the paths of the centre axis of the piston and the power transmission part are of the shape of a circular arch and symmetrical in relation to the centre point of the piston motion space.

In an advantageous embodiment of the invention in the locating device of the rotary piston mechanism, joint parts of a locating joint on the circumference surrounding the centre axis of the piston being at the end of a torque arm are at a distance of a fixed-length radius from the centre axis of the piston and static joint parts are around the centre point of the piston motion space at a distance of a fixed-length radius from the centre point. This provides the advantage that the support or the piston motions formed by the locating joint and the crank arm is statically stable in the different positions of the piston, which dampens the rotational motions of the piston and the power transmission part and friction forces loading the motions of the crank arm moving the centre axis of the piston and intensifies the run and torque of the rotary piston machine and improves the output of the rotary piston machine.

Other subclaims are described in the text below.

### DESCRIPTION OF THE DRAWINGS

The invention will now be described in more detail with reference to the accompanying drawings in which

FIG. 1 shows a cross-section of a rotary piston mechanism according to the invention,

FIG. 2 shows a cross-section and another position of the rotary piston mechanism according to FIG. 1,

FIG. 3 shows a cross-section from a different point of a rotary piston mechanism according to the invention,

FIG. 4 shows a cross-section in another position of the rotary piston mechanism according to FIG. 3, and

FIG. 5 shows a cross-section and a side view of a rotary piston mechanism according to the invention.

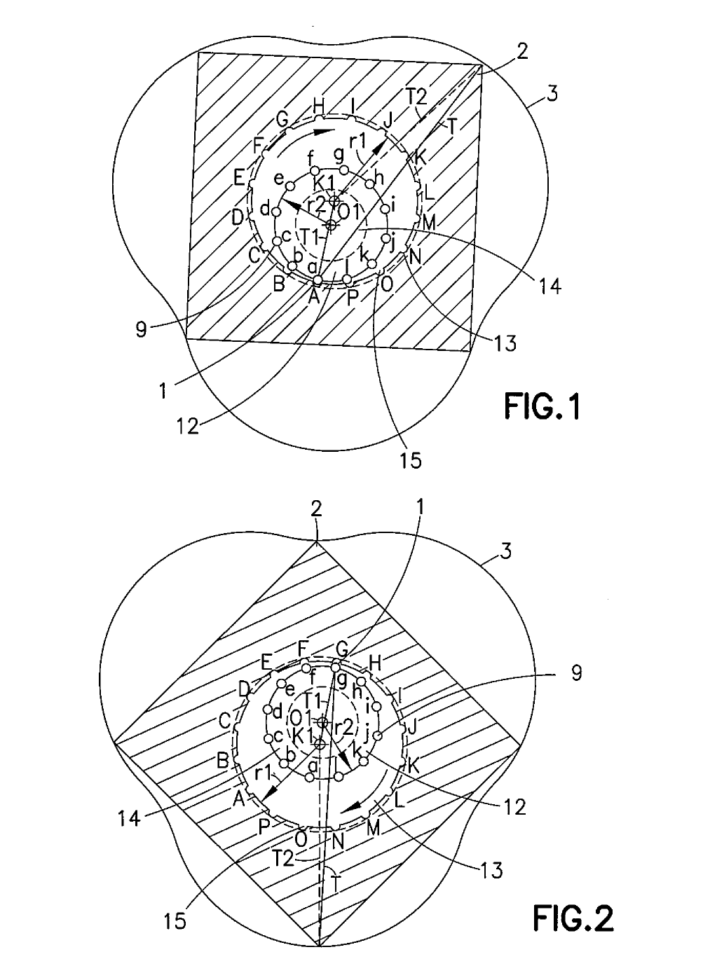

FIG. 1 shows a cross-section of an embodiment of a locating joint of the locating device of a rotary piston mechanism according to the invention, which is formed of a joint part on a circumference surrounding a centre axis of the piston at the end of a torque arm and a static joint part such that a cardan shaft is at the point of a rotation support point of a stroke motion, of an eccentric movably fastened in relation to the piston, an eccentric axis of which is at the point of a centre point of the piston motion space and a circumference of which includes touching surfaces included in the static joint part, of locators and a frame circumference being around the centre point of the motion space, of a crank arm which is between a joint part at the end of the crank arm of the piston and the centre axis of the piston, of a position of the piston in its motion space, and of a torque arm between the rotation support point and an extremity of the torque structure of the piston and a crank arm between the centre axis of the piston and the extremity of the torque structure.

FIG. 2 shows a cross-section of an embodiment of a locating joint of the locating device of a rotary piston mechanism according to the invention which is formed of another joint part on a circumference surrounding a centre axis of the piston at the end of a torque arm and another static joint part such that a cardan shaft is at the point of a rotation support point of a stroke motion, of an eccentric movably fastened in relation to the piston, an eccentric axis of which is at the point of a centre point of the piston motion space and a circumference of which includes touching surfaces included in the static joint part, of locators and a frame circumference being around the centre point of the motion space, of a crank arm which is between a joint part at the end of the crank arm of the piston and the centre axis of the piston, of another position of the piston in its motion space, and of a torque arm between the rotation support point and an extremity of the torque structure of the piston and a crank arm between the centre axis of the piston and the extremity of the torque structure.

FIG. 3 shows a cross-section of an embodiment of a crank arm included in the locating device of a rotary piston mechanism according to the invention and a power transmission part being at the end of the crank arm on the centre axis of the piston, immovably fastened in relation to the piston, and a position of the piston in its motion space.

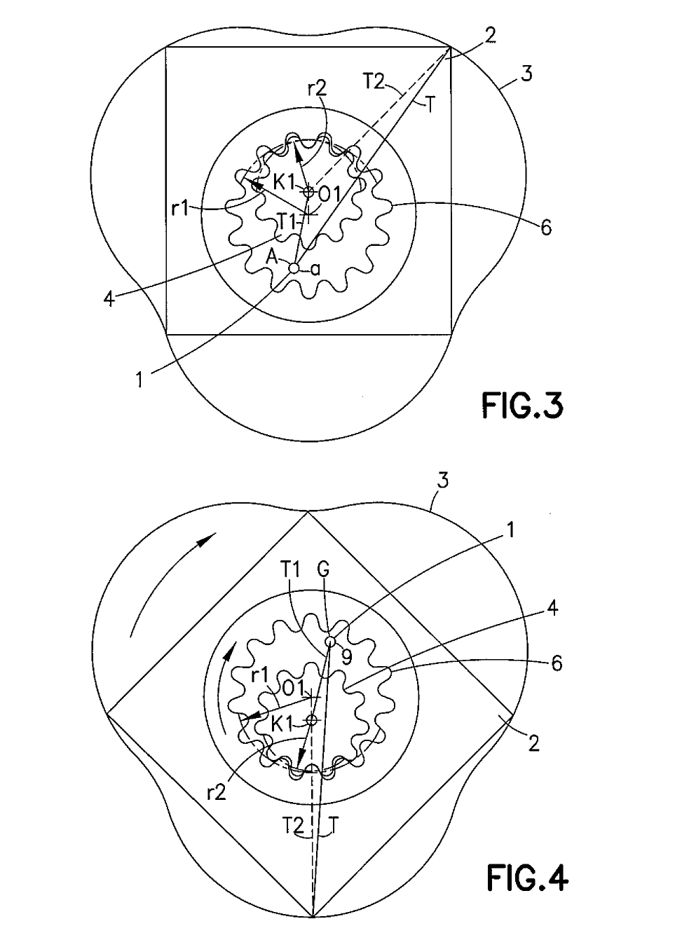

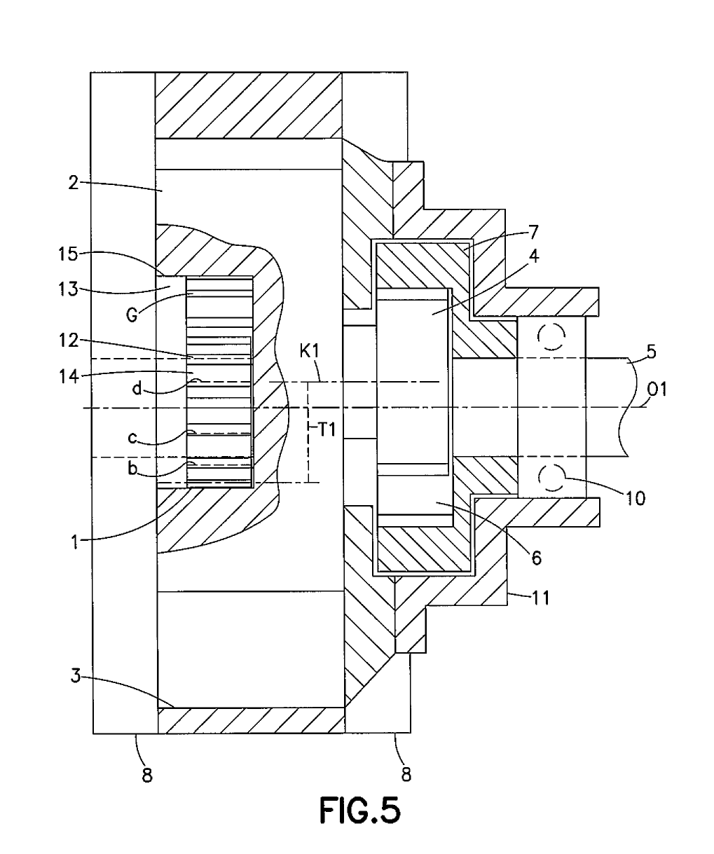

FIG. 4 shows a cross-section of an embodiment of a crank arm included in the locating device of a rotary piston mechanism according to the invention and a power transmission part being at the end of the crank arm on the centre axis of the piston, immovably fastened in relation to the piston, and another position of the piston in its motion space.

FIG. 5 shows a cross-section of an embodiment of a locating joint of the locating device of a rotary piston mechanism according to the invention, which is formed by closing a joint surface of a joint part at the end of a torque arm of the piston and a joint surface of a static joint part shown in dashed lines together such that the cardan shaft is at the point of a rotation support point, of a position of the piston in its motion space, of a power transmission part immovably fastened at the end of a crank arm on the extension of the centre axis of the piston, of a power transmission part on the crankshaft, of an eccentric movably fastened in relation to the piston, having touching surfaces belonging to the static joint part on its circumference, and an eccentric shaft is at the point of the centre point of the piston motion space, of locators and a frame circumference of the joint part being around the centre point of the piston motion space, of crankshaft bearings, of a clutch housing, of a crankshaft housing, and of covers of the piston motion space.

Figures show static joint parts a-l of a locating joint, joint parts A-P at the end of a piston torque arm, torque arms T and T2, a crank arm T1, a cardan shaft 1, a piston 2, a piston motion space 3, a power transmission part 4 on the centre axis of the piston, a crankshaft 5, a power transmission part 6 on the crankshaft, a clutch housing 7, covers 8 of the piston motion space, locators 9 around the centre point of the piston motion space, a shaft bearing 10, a crankshaft housing 11, a frame circumference 12, an eccentric 13, an eccentric shaft 14, and a piston cavity 15.

The locating device of the rotary piston mechanism includes a support structure for supporting the motions of the torque arm T between the rotation support point of the piston and the extremity of the torque structure of the piston, for supporting the motions of the torque arm T2 between the centre axis of the piston and the extremity of the torque structure of the piston, and for supporting the motions of the power transmission part 4 on the centre axis of the piston or on its extension, being immobile in relation to the piston, and the rotational motions of the moving piston 2 and the power transmission part 4 on the centre axis K1 of the piston or on its extension are supported by the locating joint which is formed by closing together one of joint parts A, B, C, D, E, F, G, H, I, J, K, L, M, N, O or P on the circumference surrounding the centre axis K1 of the piston at the end of the torque arm T and one of static joint parts a, b, c, d, e, f, g, h, i, j, k or l, the touching surfaces of both joint parts touching each other such that the cardan shaft 1 of the locating joint is in the rotation support point of the piston or in its immediate vicinity and controlled centrically by the crank arm T1 formed between the joint part at the end of the torque arm T of the piston and the centre axis K1 of the piston to the cardan shaft 1, and the closable and openable locating joints and crank arm provide a centrical and statically stable support for the motions of the piston, the motions of the power transmission parts 4, 6 in relation to each other, and the motion around the rotation support point of the power transmission part 4 on the centre axis K1 of the piston or on its extension and the rotation around the centre axis of the piston such that the path of the centre axis of the piston and the power transmission part 4 on it is of the shape of a circular arch and symmetrical in relation to the centre point O1 of the piston motion space.

According to FIGS. 1 and 2, the joint parts A-P on the circumference surrounding the centre axis K1 of the piston at the end of the torque arm T are on the wall of the piston cavity 15, and the static joint parts a-l are on the frame circumference 12 and on the wall of the eccentric 13 fastened movably in relation to the piston, and the locating joint is formed at the point of the support point of the rotational motion of the piston by closing together a touching surface of the joint part at the end of the torque arm T of the piston and touching surfaces of the static joint part on the frame circumference 12 and on the eccentric 13 circumference, and an eccentric engine component comprising the eccentric 13 and the eccentric shaft 14, fastened movable in relation to the piston, the circumference of which includes joint parts a-l, is disconnected from the power transmission loading in relation to the crankshaft. The distance of the eccentric shaft 14 being in the centre point 01 of the piston motion space 3 from the centre axis K1 of the piston is a half of the length of the diameter of the path of the centre axis of the piston.

The rotational motion of the piston 2 is arranged to rotate around the cardan shaft 1 being in the motion space 3 at the point of the rotation support shaft and the motions of the piston and the motions rotating around the support point of rotational motion of the piston of the power transmission part and the rotation around the centre axis of the piston are supported by the locating joint and the crank arm T1 such that the distance between the piston angles and the rotation support point and the centre axis K1 is constant and the centre axis K1 of the piston rotates at an even angular speed around the centre point O1 of the motion space according to piston motions.

The joint parts A-P of the locating joint on the circumference surrounding the centre axis K1 of the piston at the end of the torque arm T are at a distance of a fixed-length radius r1 from the centre axis of the piston, and the static joint parts a-l are around the centre point O1 of the piston motion space at a distance of a fixed-length radius r2 such that the locating joint closes when one of the joint parts at the end of the torque arm T and one of the joint parts in the locator 9 and the eccentric 13 circumference are at the same time at the point of the rotation support point or in its immediate vicinity. The length of the diameter of the path of the centre axis K1 of the piston is 0.335 parts of the length of the diameter of the circumference of the static joint parts a-l of the locating joint.

According to FIGS. 3 and 4, the centre axis K1 of the piston includes the power transmission part 4 immovably fastened in relation to the piston, for the rotational motion around the rotation support point according to piston motions and for rotating around the centre axis the of the piston, the motions of which are centralised and supported by the locating joint such that the cardan shaft 1 is the rotation support shaft for the motion of the power transmission part 4 moving according to piston motions rotating around the rotation support point, for the rotation around the centre axis of the piston and for the motions in relation to the power transmission part 6 on the crankshaft, and the distance between the rotation support point and the centre axis K1 of the piston is constant. The power transmission part 4 on the centre axis K1 of the piston or on its extension is a drive wheel with which together with the power transmission part 6 fastened to the crankshaft 5 is formed a wheel pair for power transmission between the piston 2 and the crankshaft such that the eccentric 13, having touching surfaces being part of the joint parts a-l on its circumference, is connected to a different shaft than the crankshaft 5 and disconnected from the power transmission loading.

According to FIG. 5, the power transmission part 4 connected to the extension of the centre axis K1 of the piston and the power transmission part 6 on the crankshaft are in the clutch housing 7, and the crankshaft 5 is aligned via the crankshaft housing 11 and the bearing 10 to the centre point O1 of the piston motion space such that a drive wheel pair is formed of the power transmission parts 4 and 6, by means of which the conveyance of motion energy is arranged between the piston 2 and the crankshaft 5, and the piston cavity 15 includes the eccentric 13 movably fastened in relation to the piston, the eccentric shaft 14 of which is in the centre point O1 of the motion space and the touching surfaces on the outer circumference of which are part of the static joint part a-k or l of the locating joint.

The rotational motions of the moving piston 2 and the power transmission part 4 on the centre axis K1 of the piston or on its extension are supported by the locating joint formed at the point of the support point of the rotational motion of the piston or in its immediate vicinity, being closable and openable according to piston positions, the cardan shaft 1 of which is at the touching point of the static joint part a-k or l formed on the frame circumference 12 or the eccentric 13 circumference or on both circumferences together and the joint part A-O or P on the circumference surrounding the centre axis K1 of the piston at the end of the torque arm, and controlled by the crank arm T1 between the joint part at the end of the torque arm T of the piston and the crank arm of the centre axis K1 of the piston to the cardan shaft 1 centrically such that the path of the centre axis of the piston and the power transmission part 4 on it is of the shape of a circular arch and symmetrical in relation to the centre point O1 of the piston motion space, and a centrical and statically stable support structure is formed for the motions of the piston 2, the motions rotating around the rotation support point of the power transmission part 4 on the centre axis K1 of the piston or on its extension and the rotation around the centre axis of the piston, the eccentric 13 in connection with which, having joint parts a-l of the locating joint on its circumference, is disconnected from the power transmission such that torque loading the mechanism will not convey between the eccentric and the piston.

The locating joint of a locating device of a rotary piston mechanism according to an embodiment of FIG. 1 is formed by the joint parts A and a being at the same time at the point of the support point of rotational motion of the piston such that the cardan shaft 1 is the rotation support shaft of the piston, and the next locating joint is closing for joint parts B and b according to the piston motion, and the previous locating joint formed by joint parts P and l has opened. The diameter of the eccentric 13 circumference movably fastened in relation to the piston is substantially of equal length as the diameter of the circumference of the joint parts A-P on the circumference surrounding the centre axis K1 of the piston at the end of the torque arm T, and the joint parts A-P are at a distance of a fixed-length radius r1 from the centre axis K1 of the piston, and the static joint parts a-l are around the centre point O1 of the motion space at a distance of a fixed-length radius r2 from the centre point. The touching surface of the joint parts A-P of the locating joint on the circumference surrounding the centre axis K1 of the piston at the end of the torque arm T is on the wall of the piston cavity 15, and the touching surfaces of the static joint parts a-l are on the eccentric 13 circumference movably fastened in relation to the piston and in the locators 9 on the frame circumference 12.

When one of the joint parts A-O or P on the circumference surrounding the centre axis K1 of the piston at the end of the torque arm T with one of the static joint parts a-k or l at the point of the support point of rotational motion of the piston are at the same point, the joint parts with their touching surfaces are closed as a locating joint, by means of which, the motions of the piston and the motions rotating around the rotation support point of the power transmission part and rotating around the centre axis of the piston are supported stabilisingly, and the crank arm T1 formed between the joint part being at the end of the torque arm T of the piston and the centre axis K1 of the piston centres the motions of the power transmission part 4 on the centre axis K1 of the rotary piston or on its extension to the locating joint. According to the measurements of this embodiment, the length of the bisector between the angular points of the rotary piston is 288.0 mm, the length of the diameter of the circumference formed of the static joints a-l of the locating joint is 87.15 mm, the length of the diameter of the circumference formed of the joint parts A-P at the torque arm of the piston is 116.35 mm, the length of the diameter of the path of the centre axis K1 of the piston is 29.2 mm, and the length of the crank arm T1 is 58.18 mm. The length of the diameter of the circumference formed of the static joint parts a-l of the locating joint is substantially 0.3026 parts of the length of the bisector between the angular points of the piston. The distance r1 of the joint parts A-P of the locating joint at the end of the torque arm T of the piston from the centre axis K1 of the piston is substantially 1.335 times greater than the distance r2 of the static joint parts a-l being around the centre point O1 of the piston motion space 3 from the centre point O1. The centre axis K1 of the piston is at the end of the crank arm T1 at a constant distance from the rotation support point.

The locating joint of a locating device of a rotary piston mechanism according to an embodiment of FIG. 2 is formed by joint parts G and g being at the same time at the point of the support point of rotational motion of the piston such that the cardan shaft 1 is the rotation support shaft of the piston. Compared with the situation shown in FIG. 1, the piston has been rotated to the right for 45 degrees around the static joint parts a, b, c, d, e and f. In the situation shown in FIG. 2, the next locating joint is closing for joint parts H and h, and the previous locating joint formed by joint parts F and f has opened.

The locating joint of a locating device of a rotary piston mechanism according to the embodiment of FIG. 3 is formed by the joint part A on the circumference surrounding the centre axis K1 of the piston at the end of the torque arm T and the static joint part a touching each other such that the cardan shaft 1 is the rotation support shaft of the piston. As the piston motion rotates around the rotation support point, the crank arm T1 affects according to the piston motion the motions of the power transmission part 4 fastened on the centre axis such that they are rotating the cardan shaft and that there is between the centre axis of the piston and the extremity of the torque structure of the piston the torque arm T2 which affects the motions of the power transmission part 4 such that they are rotating around the centre axis of the piston. The power transmission parts 4 and 6 are drive wheels the lengths of the diameters of the cam circumferences of which are 2×r2 and 2×r1, and the diameter of the cam circumference of the power transmission part 4 on the centre axis of the piston or on its extension is substantially 0.749 parts of the diameter of the cam circumference of the power transmission part 6 fastened to the crankshaft.

The locating joint of a locating device of a rotary piston mechanism according to the embodiment of FIG. 4 is formed at the point of the rotation support point by the joint part G and the joint part g touching each other such that the cardan shaft 1 is the rotation support shaft of the piston. Compared with the situation shown in FIG. 3, the piston has been rotated to the right for about 45 degrees, whereby the power transmission part 4 rotating according to the rotational motions of the piston and rotating according to the rotation has moved the crankshaft via the power transmission part 6 for the rotation of about 81 degrees.

According to the embodiment of FIG. 5, the locating device of the rotary piston mechanism closes the joint parts being at the same time at the point of the support point of rotational motion of the piston or in its immediate vicinity as a locating joint, and the previous locating joint is opened the next locating joint being formed such that a centralising and statically stable support structure is formed for the motions of the piston, the motions rotating around the rotation support point of the power transmission part on the centre axis of the piston or on its extension and for the rotation around the centre axis of the piston, and the crankshaft 5 carrying the power transmission loading is disconnected from the eccentric shaft 14 in the piston motion space such that the power transmission will not load the eccentric 13 having joint parts of the locating joint on its circumference. The motions of the piston 2 and the power transmission part 4 on the centre axis of the piston, immobile in relation to the piston are supported by a locating joint formed of the static joint part a on the frame circumference 12 and the eccentric 13 circumference and the joint part A at the end of the crank arm, the crankshaft 1 of which is the rotation support shaft of the piston, and centred by the crank arm T1 formed between the joint part on the circumference surrounding the centre axis K1 of the piston at the end of the torque arm T and the centre axis K1 of the piston such that by the locating joint and the crank arm T1 is arranged a statically stable support closable and openable according to the different positions of the piston, and for rotational motions around the rotation support point of the power transmission part 4 connected to the piston, moving according to the piston motions, and for rotation around the centre axis of the piston, and motion energy is conveyed stabilisingly via the power transmission part 4 on the centre axis of the piston or on its extension, being immobile in relation to the piston between the piston and the crankshaft, and the eccentric 13, having joint parts a-l of the locating joint on its circumference, is disconnected from the power transmission such that the torque loading the mechanism will not convey between the eccentric and the piston.

The crankshaft 5 and the centre axis of the power transmission part 6 are aligned by the housing 11 and the shaft bearing 10 to the centre point O1 of the piston motion space, and the power transmission part 4 on the centre axis of the piston, immobile in relation to the piston and the power transmission part 6 on the crankshaft 5 are within each other as a drive wheel pair by means of which the conveyance of motion energy is arranged between the piston and the main shaft. The joint surfaces described by dashed lines are in the locators 9 in the frame circumference 12 and the touching surface on the circumference of a circular disc 13 aligned to the joint surfaces on the circumference surrounding the centre axis K1 of the piston at the end of the torque arm T such that, in the stroke motion of the piston, the cardan shaft 1 of the locating joint is at the point of the rotation support point or in its immediate vicinity. The distance of the eccentric shaft 14 in the centre point O1 of the piston motion space 3 from the centre axis K1 of the piston is a half of the length of the diameter of the path of the centre axis of the piston, and the motions of the piston, the motions rotating around the rotation support point of the power transmission part on the centre axis of the piston or on its extension and the rotation around the centre axis of the piston are supported by the locating joint of the locating device of the support and centred by the crank arm T1 such that the centre axis K1 of the piston is rotatable from the rotation support point at a constant distance, and the locating device of the rotary piston mechanism closes the joint parts being at the point of the support point of the rotational motion of the piston or in its immediate vicinity at the same time as a locating joint, and the previous locating joint is opened when the next locating joint is being formed such that a centrical and statically stable support structure is formed for the motions of the piston, the motions rotating around the rotation support point of the power transmission part 4 on the centre axis of the piston or on its extension and the rotation around the centre axis of the piston.

A locating device of a rotary piston mechanism according to the invention includes a support structure for supporting the motions of the torque arm between the rotation support point of the piston and the extremity of the torque structure of the piston and for supporting the motion of the power transmission part on the centre axis of the piston or on its extension, being immobile in relation to the piston.

According to the inventive idea, the locating device of the rotary piston mechanism includes a locating joint formed at the point of the support point of rotational motion of the piston or in its immediate vicinity, closable and openable according to piston positions, and by the locating joints and the crank arm is formed a centrical and statically stable support structure for the motions of the piston, the motions rotating around the rotation support point of the power transmission part on the centre axis of the piston or on its extension and rotating around the centre axis of the piston, the eccentric in connection with which, having joint parts of the locating joint on its circumference, is disconnected from the power transmission such that the torque loading the engine will not convey between the eccentric and the piston.

It is also possible to consider arrangements different from the ones described above within the inventive idea constituted by the patent claims. Hence, the locating device of the rotary piston mechanism can be in connection with a triangular or hexagonal or e.g. elliptical rotary piston and a power transmission part on the centre axis of the piston.

According to an embodiment of the invention, the locating device of a rotary piston mechanism is in a rotary piston mechanism in which the walls of the piston motion space are of the shape of cycloid arches.

The rotary piston structure according to the invention can be used in various devices which include a rotary piston. Such devices are, inter alia, rotary piston engines, rotary piston pumps and other rotary piston machines.

The invention is not limited to the advantageous embodiments described but it can vary within the scope of the inventive idea defined by the claims.

1. A locating device of a rotary piston mechanism which comprises
a support structure for supporting motions of a torque arm between a rotation support point of a piston and an extremity of a torque structure of the piston,
for supporting the motions of a torque arm between a centre axis of the piston and the extremity of the torque structure of the piston,
for supporting the motions of a power transmission part on the centre axis of the piston or on its extension, being immobile in relation to the piston,
rotational motions of the moving piston and the power transmission part on the centre axis of the piston or on its extension is supported by a locating joint formed at the point of the support point of the rotational motion of the piston or in its immediate vicinity, being closable and openable according to piston positions,
a cardan shaft of which is at the touching point of a static joint part formed on a frame circumference or an eccentric circumference or on both circumferences together
a joint part on a circumference surrounding the centre axis of the piston at the end of a torque arm, and controlled by a crank arm between a joint part at the end of the torque arm of the piston and the crank arm of the centre axis of the piston to the cardan shaft centrically such that the path of the centre axis of the piston and the power transmission part on it is of the shape of a circular arch and symmetrical in relation to the centre point of the motion space of the piston,
a centrical and statically stable support structure is formed for the motions of the piston, the motions rotating around the rotation support point of the power transmission part on the centre axis of the piston or on its extension and the rotation around the centre axis of the piston, an eccentric in connection with which, having joint parts of the locating joint on its circumference, is disconnected from the power transmission such that torque loading the mechanism will not convey between the eccentric and the piston.

2. A locating device of a rotary piston mechanism according to claim 1, in which
joint parts of the locating joint on the circumference surrounding the centre axis of the piston being at the end of the torque arm are at a distance of a fixed-length radius from the centre axis of the piston, and
the static joint parts are around the centre point of the piston motion space at a distance of a fixed-length radius from the centre point.

3. A locating device of a rotary piston mechanism according to claim 1, in which
the diameter of the circumference of the eccentric movably fastened in relation to the piston is substantially of equal length as the diameter of the circumference of joint parts on the circumference surrounding the centre axis of the piston at the end of the torque arm.

4. A locating device of a rotary piston mechanism according to claim 1, in which
the touching surface of the joint parts of the locating joint on the circumference surrounding the centre axis of the piston at the end of the torque arm is on the wall of a piston cavity.

5. A locating device of a rotary piston mechanism according to claim 1, in which
the length of the diameter of the circumference formed of the static joint parts of the locating joint is substantially 0.3026 parts of the length of the bisector between the angular points of the piston.

6. A locating device of a rotary piston mechanism according to claim 1, in which
the distance of the joint parts at the end of the torque arm of the piston from the centre axis of the piston is substantially 1.335 times greater than the distance of the static joint parts around the centre point of the piston motion space from the centre point.

7. A locating device of a rotary piston mechanism according to claim 1, in which
the length of the diameter of the path of the centre axis of the piston is 0.335 parts of the length of the diameter of the circumference of the static joint parts.

8. A locating device of a rotary piston mechanism according to claim 1, in which
the distance of the eccentric shaft being in the centre point of the piston motion space from the centre axis of the piston is a half of the length of the diameter of the path of the centre axis of the piston.
